(19) United States
(12) Patent Application Publication
(10) Pub. No.: US 2025/0084215 A1
(43) Pub. Date: Mar. 13, 2025

(54) TRANSLUCENT LOW-DIELECTRIC POLYIMIDE FILM AND MANUFACTURING METHOD THEREFOR

(71) Applicant: PI ADVANCED MATERIALS CO., LTD., Chungcheongbuk-do (KR)

(72) Inventors: Min-Sang CHO, Incheon (KR); Sung-Yul BACK, Seoul (KR); Kil-Nam LEE, Bucheon (KR)

(21) Appl. No.: 18/573,874

(22) PCT Filed: Jun. 24, 2022
(86) PCT No.: PCT/KR2022/009019

§ 371 Date: Dec. 22, 2023

(30) Foreign Application Priority Data
Jun. 25, 2021 (KR) 10-2021-0083076

(51) Int. Cl. C08G 73/10; C08J 5/18

(52) U.S. Cl. CPC C08G 73/1014; C08G 73/1042; C08J 5/18; C08J 2379/08

(57) ABSTRACT

The present invention provides a polyimide film and a manufacturing method therefor, the polyimide film having a dielectric dissipation factor (Df) of 0.003 or less, a haze of 3.5% or less, a transmittance of 45% or greater, and a glass transition temperature (Tg) that is equal to or greater than 300° C. and is less than 320° C.

### TECHNICAL FIELD

The present disclosure relates to a polyimide film that is translucent and exhibits low dielectric properties and a method of manufacturing the same.

### BACKGROUND ART

Polyimide (PI) is based on an imide ring showing very excellent chemical stability with a rigid aromatic main chain, and thus polyimide is a polymer material with the highest level of heat resistance, drug resistance, electrical insulation properties, chemical resistance, and weather resistance among organic materials.

In particular, polyimide exhibits excellent insulation properties, in other words, excellent electrical properties such Accordingly, polyimide is attracting as low permittivity.

attention as a highly functional polymer material in the electrical, electronic, and optical fields.

Recently, due to the trend for the lightweightness, miniaturization, or both of electronic products, thin circuit boards with high integration and flexibility are being actively developed.

These thin circuit boards tend to have a structure in which a circuit including metal foil is formed on a polyimide film that has excellent heat resistance, low-temperature resistance, and insulation properties, as well as ease of bending.

Flexible metal clad laminates are mainly used as such thin circuit boards, and an example of the flexible metal clad laminates includes a flexible copper clad laminate (FCCL), which uses a thin copper plate as a metal foil. In addition, polyimide is also used as a protective film and insulation film for thin circuit boards.

Meanwhile, as various functions have recently become embedded in electronic devices, the fast calculation and communication speeds of the electronic devices are required. To meet these requirements, thin circuit boards capable of high-speed communication at high frequencies are being developed.

To realize high-frequency, high-speed communication, an insulator with a high impedance is needed to be able to maintain electrical insulation properties even at high frequencies. Since impedance is inversely proportional to the frequency and dielectric constant (Dk) of the insulator, the dielectric constant is required to be as low as possible to maintain the insulation properties even at high frequencies.

However, conventional polyimide does not have dielectric properties as excellent as to maintain sufficient insulation properties in high-frequency communication.

In addition, it is known that the lower the dielectric properties of the insulator, the lower the occurrence of undesirable stray capacitance and noise in thin circuit boards, thereby eliminating many of the causes of communication delays.

Therefore, polyimide with low dielectric properties is recognized as an important factor in the performance of thin circuit boards.

In particular, in the case of high-frequency communication, dielectric dissipation of polyimide inevitably occurs. The dielectric dissipation factor (Df) refers to the degree of electrical energy wasted in thin circuit boards and is closely related to the signal transmission delay that determines the communication speed, so keeping the dielectric dissipation factor of polyimide as low as possible is also recognized as an important factor for the performance of the thin circuit boards.

In addition, as products are being developed one after another in fields that require the use of transparent insulation substrates, such as in the transparent display field, the need for polyimide with certain transparency (low haze) is increasing.

There are applied methods to increase the transparency of the normally dark brown polyimide film. The methods are of limiting the movement of I electrons by using a weak electron acceptor dianhydride or a weak electron donor diamine, of reducing the CTC effect by introducing bulky substituents, and asymmetric or non-planar structures to the main chain, or of inhibiting the formation of resonance structure of π electrons by introducing an aliphatic anhydride or an aliphatic diamine.

However, these methods not only deteriorate the thermal stability and mechanical properties of the polyimide film but also increase the permittivity of the polyimide film, limiting the use of the film in fields requiring low dielectric properties.

In addition, monomers with complex structures and high unit costs are mainly used, and thus the raw material cost of the transparent polyimide film is very high.

Therefore, there is a need for the development of a polyimide film that has a certain degree of transparency while maintaining the inherent thermal stability and mechanical properties of polyimide and at the same time having low dielectric properties.

### RELATED ART DOCUMENT

### Patent Document

(Patent Document 1) Korean Patent Application Publication No. 2003-0027249.

### DISCLOSURE

### Technical Problem

To solve the problems, an objective is to provide a translucent polyimide film with low dielectric properties and a method of manufacturing the same.

In particular, the objective is to provide a low-cost polyimide film with low dielectric and translucent (low haze) properties by using a combination of conventional monomers rather than monomers with a complex structure.

Accordingly, the practical objective of the present disclosure is to provide specific examples thereof.

### Technical Solution

To achieve the objective,
one embodiment of the present disclosure provides a method of manufacturing a polyimide film including:
(a) preparing a polyamic acid by polymerizing a first dianhydride component, a second dianhydride component, and a diamine component in an organic solvent; and
(b) forming a film of a precursor composition containing the polyamic acid on a support and then imidizing the film,
in which the first dianhydride component is any one selected from the group consisting of oxydiphthalic anhydride (ODPA), biphenyltetracarboxylic dianhydride (BPDA), pyromellitic dianhydride (PMDA), and benzophenone tetracarboxylic dianhydride (BTDA),
the second dianhydride component is any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA),
the diamine component is at least one selected from the group consisting of paraphenylene diamine (PPD), diaminodiphenylether (ODA), m-tolidine, 1,3-bis(4-aminophenoxy)benzene (TPE-R), 1,4-bis(3-aminophenoxy)benzene (TPE-Q), 2,2-bis[4-(4-aminophenoxy)phenyl]propane (BAPP), 4,4′-diaminobenzanilide, and 3,5-diaminobenzoic acid (DABA),
the polyimide film has a dielectric dissipation factor (Df) in the range of 0.003 or less and a haze value in the range of 3.5% or less.
(but the first dianhydride component and the second dianhydride component are different from each other)

Another embodiment of the present disclosure provides
a polyimide film manufactured by the manufacturing method.

A further embodiment of the present disclosure provides
a multilayer film including the polyimide film and a thermoplastic resin layer.

A yet further embodiment of the present disclosure provides
a flexible metal clad laminate including the polyimide film and an electrically conductive metal foil.

A yet further embodiment of the present disclosure provides
an electronic component including the flexible metal clad laminate.

A yet further embodiment of the present disclosure provides a polyimide film
with a dielectric dissipation factor (Df) in the range of 0.003 or less and
a haze value in the range of 3.5% or less.

### Advantageous Effects

As described above, the present disclosure provides a polyimide film containing certain components in a specific composition ratio and a method of manufacturing the same, thereby providing a low-cost polyimide film with low dielectric and translucent (low haze) properties. The low-cost, low-dielectric, and translucent polyimide film can be applied to various fields where the film is required, especially to an electronic component such as a flexible metal clad laminate.

### BEST MODE

Hereinafter, examples will be described in more detail in the order of “polyimide film” and “method of manufacturing the same” according to the present disclosure.

Before this, the terms or words used in this specification and claims should not be construed as limited to their usual or dictionary meanings, and the inventor(s) should appropriately define the concept of terms to explain his or her disclosure in the best way. The terms or words are required to be interpreted as meaning and concepts consistent with the technical idea of the present disclosure based on the principle of definability.

Therefore, the configuration of the examples described in this specification is only one of the most preferred examples of the present disclosure and does not represent the entire technical idea of the present disclosure, so it should be understood that various equivalents and modifications that can replace them may exist at the time of applying for the present disclosure.

In this specification, singular expressions include plural expressions, unless the context dictates otherwise. In this specification, terms such as “include”, “comprise”, or “have” are intended to designate the presence of implemented features, numbers, steps, components, or a combination thereof, and it should be understood that this does not exclude in advance the possibility of the presence or addition of one or more other features or numbers, steps, components, or combinations thereof.

When amounts, concentrations, or other values or parameters are given herein as ranges, preferred ranges, or enumerations of upper preferred values and lower preferred values, any pair of upper range limits or the preferred values and any lower range limits or all ranges formed from the preferred values should be understood to be specifically disclosed regardless of whether the ranges are separately disclosed.

When a range of numerical values is stated herein, unless otherwise stated, the range is intended to include the endpoints and all integers and fractions within the range. The scope of the disclosure is not intended to be limited to the specific values when defining the ranges.

As used herein, “dianhydride” is intended to include precursors or derivatives thereof, which may not technically be dianhydride but will react with diamine to form polyamic acid, which in turn will convert to polyimide.

As used herein, “diamine” is intended to include precursors or derivatives thereof, which may not technically be diamine but will react with dianhydride to form a polyamic acid, which in turn will convert to polyimide.

The polyimide film according to one aspect of the present disclosure may have a dielectric dissipation factor (Df) in the range of 0.003 or less and a haze value in the range of 3.5% or less. Even when a polyimide film is manufactured using some of the same or similar monomers as the present disclosure, it is difficult to secure low dielectric properties when the dielectric dissipation factor in the range is not achieved, and at the same time, when the haze value in the range is not achieved, the light transmitted through the film may be excessively diffused, and thus it is difficult to achieve translucency of the film.

Preferably, the dielectric dissipation factor (Df) may be in the range of 0.0029 or less, and the haze value may be in the range of 3.3% or less.

Therefore, a conventional low-dielectric polyimide film is very dark brown and has little transparency meanwhile the polyimide film has a technical advantage in that the polyimide film has low dielectric properties and at the same time has translucency due to low haze.

In addition, the polyimide film may have a light transmittance in the range of 45% or more and a glass transition temperature (Tg) in the range of 300° C. or more and less than 320° C. Therefore, the polyimide film of the present disclosure has the technical advantage of having a high light transmittance and a glass transition temperature so that the film can be used as an insulation film for a flexible metal clad laminate. Preferably, the glass transition temperature (Tg) may be in the range of 305° C. or lower.

In one embodiment, a first dianhydride component is any one selected from the group consisting of 4,4′-oxydiphthalic anhydride (ODPA), 3,3′,4,4′-biphenyltetracarboxylic dianhydride (BPDA), pyromellitic dianhydride (PMDA), and 3,3′,4,4′-benzophenonetetracarboxylic dianhydride (BTDA).

Next, a second dianhydride component is any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA).

Afterward, a diamine component is at least one selected from the group consisting of paraphenylene diamine (PPD), diaminodiphenylether (4,4′-oxydianiline, ODA), m-tolidine, 1,3-bis(4-aminophenoxy)benzene (TPE-R), 1,4-bis(3-aminophenoxy)benzene (TPE-Q), 2,2-Bis[4-(4-aminophenoxy)phenyl]propane (BAPP), 4,4′-diaminobenzanilide, and 3,5-diaminobenzoic acid (DABA). Lastly, the first dianhydride component, the second dianhydride component, and the diamine component are subjected to an imidization reaction to obtain the polyimide film.

Additionally, the first dianhydride component and the second dianhydride component may be different from each other.

For example, the first dianhydride component, the second dianhydride component, and the diamine component may be biphenyltetracarboxylic dianhydride (BPDA), oxydiphthalic anhydride (ODPA), and paraphenylene diamine (PPD), respectively.

In one embodiment, the first dianhydride component may have a content in the range of 40 mol % or more to 95 mol % or less, and the second dianhydride component may have a content in the range of 5 mol % or more to 60 mol % or less, based on 100 mol % of the dianhydride components of the polyimide film.

Preferably, the first dianhydride component may have a content in the range of 45 mol % or more to 80 mol % or less, and the second dianhydride component may have a content in the range of 15 mol % or more to 50 mol % or less, based on 100 mol % of the dianhydride components of the polyimide film.

When the first dianhydride component may have a content in the range of less than 40 mol % or more than 95 mol %, and the second dianhydride component may have a content in the range of less than 5 mol % or more than 60 mol %, based on 100 mol % of the dianhydride components of the polyimide film, the dielectric dissipation factor of the polyimide film increases, which in turn may deteriorate the dielectric properties or the mechanical properties of the polyimide film.

In one embodiment, the polyimide film further contains a third dianhydride component with a content in the range of 5 mol % or less, based on 100 mol % of the dianhydride components of the polyimide film.

The third dianhydride component may be any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA).

Additionally, the third dianhydride component may be different from the first dianhydride component and the second dianhydride component.

For example, the third dianhydride may be pyromelliticdianhydride and may be used to adjust viscosity when preparing a polyamic acid.

Meanwhile, the polyimide chain derived from biphenyltetracarboxylic dianhydride, which can be used as the dianhydride components of the polyimide film, has a regular straight structure called charge transfer complex (CTC), that is, the electron donor and electron acceptor are located close to each other. Accordingly, the intermolecular interaction of polyimide is strengthened.

Since this structure has the effect of preventing hydrogen bonding with moisture, the structure can have an effect in lowering the moisture absorption rate and maximize the effect of lowering the hygroscopicity of the polyimide film.

For the polyimide film to have both the satisfactory appropriate elasticity and moisture absorption rate, the content ratio of dianhydride is particularly important. For example, as the content ratio of biphenyltetracarboxylic dianhydride decreases, it becomes difficult to expect a low moisture absorption rate due to the CTC structure.

In addition, oxydiphthalic anhydride, which can be used as dianhydride components of the polyimide film, contains two benzene rings located in the aromatic portion like biphenyltetracarboxylic dianhydride, resulting in a much lower moisture absorption rate.

In this regard, the polyimide film that satisfies the appropriate ranges of both the dielectric dissipation factor (Df) and glass transition temperature can be used as an insulation film for a flexible metal clad laminate. In addition, even when the manufactured flexible metal clad laminate is used as electrical signal transmission circuits that transmit signals at a high frequency in the range of 10 GHz or more, the insulation stability of the flexible metal clad laminate can be ensured and signal transmission delay can be minimized.

Herein below, the dielectric dissipation factor (Df) will be described in detail.

### Dielectric Dissipation Factor (Df)

“Dielectric dissipation factor” means the force dissipated by a dielectric (or an insulator) when the friction of the molecules counteracts the molecular motion caused by an alternating electric field.

The value of the dielectric dissipation factor is commonly used as an index indicating the ease of charge loss (dielectric loss). The higher the dielectric dissipation factor, the easier it is for charges to be lost, and conversely, the lower the dielectric loss rate, the more difficult it is for charges to be lost. In other words, the dielectric dissipation factor is a measure of power loss. As the dielectric dissipation factor is lower, signal transmission delay due to power loss is alleviated and communication speed can be maintained faster.

This is a strong requirement for the polyimide film, which is an insulation film, and the polyimide film according to the present disclosure can have a dielectric dissipation factor in the range of 0.003 or less under a very high frequency of 10 GHz.

The methods of preparing a polyamic acid in the present disclosure are as follows.
(1) The entire amount of diamine component is added in a solvent and then dianhydride components are added in substantially equimolar amounts to the diamine component, and the components are polymerized for preparation of the polyamic acid;
(2) The entire amount of dianhydride components is added in a solvent, and then the diamine component is added in substantially equimolar amounts to the dianhydride components, and the components are polymerized for preparation of the polyamic acid;
(3) Some of diamine component is added into the solvent before mixing some of dianhydride components as reaction components in a content ratio of about 95 mol % to 105 mol %. Next, the remaining diamine component is added thereto. Subsequently, the remaining dianhydride components are added to the solution so that the diamine component and the dianhydride components are substantially equimolar, and the components are polymerized for preparation of the polyamic acid;
(4) Dianhydride components are added into the solvent before some of the diamine compound as a reaction component are mixed in a content ratio of 95 mol % to 105 mol %. Next, other dianhydride components are added thereto. Subsequently, the remaining diamine component is added to the solution so that the diamine component and the dianhydride components are substantially equimolar, and the components are polymerized for the preparation of the polyamic acid;
(5) A first composition is prepared by reacting some diamine component and some dianhydride components in a solvent as either one is in excess. A second composition is prepared by reacting some diamine component and some dianhydride components in another solvent as either one is in excess. Afterward, the prepared first and second compositions are mixed. As a method of completing polymerization, when the diamine component is excessive when preparing the first composition, the dianhydride components are added in excess in the second composition, and when the dianhydride components are excessive in the first composition, the diamine component is added in excess in the second composition. Through this, the total diamine component and dianhydride components used in the reaction are substantially equimolar, and the polyamic acid is polymerized by mixing and reacting the first and second compositions.

However, the polymerization method is not limited to the mentioned methods, and of course, any known method can be used to prepare the polyamic acid.

In one specific example, another aspect of the present disclosure provides a method of manufacturing a polyimide film including:
(a) preparing a polyamic acid by polymerizing a first dianhydride component, a second dianhydride component, and a diamine component in an organic solvent; and
(b) forming a film of a precursor composition containing the polyamic acid on a support and then imidizing the film,
in which the first dianhydride component may be any one selected from the group consisting of oxydiphthalic anhydride (ODPA), biphenyltetracarboxylic dianhydride (BPDA), pyromellitic dianhydride (PMDA), and benzophenone tetracarboxylic dianhydride (BTDA),
the second dianhydride component may be any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA), and
the diamine component may be at least one selected from the group consisting of paraphenylene diamine (PPD), diaminodiphenylether (ODA), m-tolidine, 1,3-bis(4-aminophenoxy)benzene (TPE-R), 1,4-bis(3-aminophenoxy)benzene (TPE-Q), 2,2-bis[4-(4-aminophenoxy)phenyl]propane (BAPP), 4,4′-diaminobenzanilide, and 3,5-diaminobenzoic acid (DABA).

Additionally, the first dianhydride component and the second dianhydride component may be different from each other.

In one embodiment, in preparation of the polyamic acid, after the diamine component is added, the first dianhydride component is added and polymerized first, and then the second dianhydride component is added and polymerized. In that order, the polyimide film can be manufactured.

The polyimide film manufactured following this input order showed low dielectric and low haze properties. However, when the input order was changed (particularly, when the input order of the first dianhydride and the second dianhydride was changed), the dielectric loss value of the manufactured polyimide film increased, resulting in a decrease in low dielectric properties and a decrease in light transmittance properties.

That is, the input order in which the diamine component and the dianhydride components are added may affect the dielectric and optical properties of the manufactured polyimide film.

The polymerization methods of polyamic acid as described above can be defined as random polymerization methods. The polyimide film made from the polyamic acid of the present disclosure and through the processes can be preferably applied in terms of optimizing the effect of the present disclosure such as in lowering the dielectric dissipation factor (Df) and moisture absorption rate and providing low haze properties.

However, since the polymerization methods make a relatively short length of the repeating unit in the polymer chain described above, there may be limitations in demonstrating each of the excellent properties of the polyimide chain derived from the dianhydride components. Therefore, the polymerization methods of polyamic acid in the present disclosure may use a block polymerization method.

On the other hand, the solvent for synthesizing polyamic acid is not particularly limited, and any solvent can be used as long as it dissolves the polyamic acid, but the solvent is preferably an amide-based solvent.

Specifically, the solvent may be an organic polar solvent, and in particular, may be an aprotic polar solvent. For example, the solvent is at least one selected from the group consisting of, but not limited to, N,N-dimethylformamide (DMF), N,N-dimethylacetamide, N-methyl-pyrrolidone (NMP), gamma butyrolactone (GBL), and diglyme. The solvent may be used alone or in combination of two or more types as needed.

In one example, N,N-dimethylformamide and N,N-dimethylacetamide may be particularly preferably used as the solvent.

Additionally, in the polyamic acid preparation process, fillers may be added to improve various properties of the film such as sliding properties, thermal conductivity, corona resistance, and loop hardness. The added fillers are not particularly limited, but preferred examples include silica, titanium oxide, alumina, silicon nitride, boron nitride, calcium hydrogen phosphate, calcium phosphate, and mica.

The particle size of the fillers is not particularly limited and may be determined depending on the film properties to be modified and the type of fillers to be added. Generally, the average particle diameter of the fillers is in the range of 0.05 μm to 100 μm, preferably 0.1 μm to 75 μm, more preferably 0.1 μm to 50 μm, and particularly preferably 0.1 μm to 25 μm.

When below the range of the particle size, it becomes difficult to achieve a modifying effect, and when above this range of the particle size, the surface properties of the films or the mechanical properties may significantly deteriorate.

Additionally, the content of fillers added is not particularly limited and may be determined based on the film properties to be modified and the particle size of the fillers.

Generally, the fillers are added in the amount of 0.01 parts to 100 parts by weight, preferably 0.01 parts to 90 parts by weight, and more preferably 0.02 parts to 80 parts by weight, based on 100 parts by weight of polyimide.

When below the range in the amount of filler added, it is difficult to achieve a modifying effect due to the fillers, and when above the range in the amount of filler added, the mechanical properties of the film may significantly deteriorate. The methods of adding the fillers are not particularly limited, and any known method may be used.

In the manufacturing methods of the present disclosure, the polyimide film can be manufactured through a thermal imidization method and a chemical imidization method.

In addition, the polyimide film may be manufactured through a complex imidization method in which the thermal imidization method and chemical imidization method are combined.

The thermal imidization method is a method of inducing an imidization reaction using a heat source such as hot air or an infrared ray dryer, excluding chemical catalysts.

The thermal imidization method can imidize the amic acid group present in the gel film by heat-treating the gel film at a variable temperature in the range of 100° C. to 600° C., specifically 200° C. to 500° C., more specifically 300° C. to 500° C.

However, even in the process of forming a gel film, some of the amic acid (about 0.1 mol % to 10 mol %) may be imidized. To the end, the polyamic acid composition can be dried at a variable temperature in the range of 50° C. to 200° C., and this can also be included in the scope of the thermal imidization method.

In the case of chemical imidization, a polyimide film can be manufactured using a dehydrating agent and an imidizing agent according to methods known in the art.

As an example of a complex imidization method, a dehydrating agent and an imidizing agent are added to a polyamic acid solution, then heated at a temperature in the range of 80° C. to 200° C., preferably 100° C. to 180° C., partially cured and dried, and then heated at a temperature in the range of 200° C. to 400° C. for 5 seconds to 400 seconds, thereby the polyimide film can be manufactured.

The polyimide film of the present disclosure manufactured according to the manufacturing methods has a dielectric dissipation factor (Df) in the range of 0.003 or less, a haze value in the range of 3.5% or less, a light transmittance in the range of 45% or more, and a glass transition temperature (Tg) in the range of 300° C. or more or less than 320° C.

The present disclosure provides a multilayer film including the described polyimide film and a thermoplastic resin layer and provides a flexible metal-clad laminate including the described polyimide film and an electrically conductive metal foil.

As the thermoplastic resin layer, for example, a thermoplastic polyimide resin layer may be applied.

There is no particular limitation on the metal foil used, but when using the flexible metal clad laminate of the present disclosure for electronic or electrical devices, the metal foil may contain, for example, copper or copper alloy, stainless steel or its alloy, nickel or nickel alloy (42 alloy also included), and aluminum or aluminum alloy.

In general flexible metal clad laminate, copper foils such as rolled copper foil and electrolytic copper foil are widely used and can also be preferably used in the present disclosure. Additionally, a rust-prevention layer, a heat-resistant layer, or an adhesive layer may be applied to the surface of these metal foils.

In the present disclosure, the thickness of the metal foil is not particularly limited and may be sufficient to provide sufficient function depending on the intended use.

The flexible metal clad laminate according to the present disclosure may have a structure in which the metal foil is laminated on one side of the polyimide film or a structure in which an adhesive layer containing thermoplastic polyimide is added to one side of the polyimide film, and the metal foil already attached to adhesive layer is laminated.

The present disclosure also provides an electronic component t including the flexible metal clad laminate as an electrical signal transmission circuit. The electrical signal transmission circuit may be an electronic component that transmits a signal at a high frequency of at least 2 GHz, specifically at a high frequency of at least 5 GHz, and more specifically at a high frequency of at least 10 GHz.

The electronic component may be, for example, a communication circuit for a portable terminal, a communication circuit for a computer, or a communication circuit for aerospace, but is not limited thereto.

### MODE FOR DISCLOSURE

Hereinafter, the operation and effects of the disclosure will be described in more detail through specific examples of the disclosure. However, these examples are merely presented as examples of the disclosure, and the scope of the disclosure is not determined by the examples.

### Preparation Example

DMF was added while nitrogen was injected into a 500 ml reactor equipped with an agitator and nitrogen injection/discharge pipe, and the temperature of the reactor was set to 30° C. or lower. Afterward, paraphenylene diamine as a diamine component, biphenyltetracarboxylic dianhydride as a first dianhydride component, and oxydiphthalic anhydride as a second dianhydride component were added to the reactor and confirmed to be completely dissolved.

The input order of the diamine component and the dianhydride components was paraphenylene diamine (PPD), biphenyltetracarboxylic dianhydride (BPDA), and oxydiphthalic anhydride (ODPA) in order.

After increasing the temperature to 40° C. under a nitrogen atmosphere and continuing the reaction with agitating for 120 minutes, the viscosity was adjusted by adding a 10% solution of pyromelliticdianhydride (PMDA) in portions, thereby a polyamic acid solution with the viscosity of 200,000 cP at a temperature of 23° C. was prepared.

The polyamic acid solution prepared was rotated at a high speed of 1,500 rpm or more to remove air bubbles. Next, a deformed polyimide precursor composition was applied to the glass substrate using a spin coater. Afterward, the deformed polyimide precursor composition was dried under a nitrogen atmosphere and at a temperature of 120° C. for 30 minutes to prepare a gel film. The gel film was heated to a temperature of 450° C. at a speed of 2° C./min, heat-treated at a temperature of 450° C. for 60 minutes, and cooled to a temperature of 30° C. at a speed of 2° C./min to obtain a polyimide film.

Afterward, the polyimide film was peeled from the glass substrate by dipping the film in distilled water. The thickness of the manufactured polyimide film was in the range of 25 μm to 30 μm. The thickness of the manufactured polyimide film was measured using an electric film thickness tester from Anritsu.

### Examples 1 to 4 and Comparative Examples 1 to 3

In the preparation example, each polyimide film was manufactured by changing the components and contents thereof as shown in Table 1 below.

In the case of Comparative Examples 2 and 3, the composition and composition ratio were the same as those of Examples 1 and 4, respectively, but the input order of the diamine component and the dianhydride components were paraphenylene diamine, oxydiphthalic anhydride, and phenyltetracarboxylicdianhydride in order.

That is, the input orders of oxydiphthalic anhydride and biphenyltetracarboxylic dianhydride of Comparative Examples 2 and 3 were reversed from those of Examples 1 and 4.

TABLE 1

| | BPDA | ODPA | PMDA | PPD |
|---|---|---|---|---|
| | (mol %) | (mol %) | (mol %) | (mol %) |
| Example 1 | 78 | 19 | 3 | 100 |
| Example 2 | 73 | 24 | 3 | 100 |
| Example 3 | 69.3 | 27.7 | 3 | 100 |
| Example 4 | 65 | 32 | 3 | 100 |
| Example 5 | 58.2 | 38.8 | 3 | 100 |
| Example 6 | 48.5 | 48.5 | 3 | 100 |
| Comparative | 100 | — | 3 | 100 |
| Example 1 | | | | |
| Comparative | 78 | 19 | 3 | 100 |
| Example 2 | | | | |
| Comparative | 65 | 32 | 3 | 100 |
| Example 3 | | | | |

### <Experimental Example> Evaluation of Dielectric Dissipation Factor, Haze, Light Transmittance, and Glass Transition Temperature

The dielectric dissipation factor, haze, light transmittance, and glass transition temperature of the polyimide films manufactured in Examples 1 to 6 and Comparative Examples 1 to 3 were measured, and the results are shown in Table 2 below.

### (1) Measurement of Dielectric Dissipation Factor

The manufactured film was dried at a temperature of 130° C. for 30 minutes and then subjected to aging for 24 hours in a constant temperature and humidity chamber maintained at a temperature of 23° C. and relative humidity of 50% for pretreatment of the film, and the dielectric dissipation factor (Df) of the film was measured. Afterward, dielectric properties were measured at a frequency of 10 Ghz in the Split Post Dielectric Resonator (SPDR) measurement method using Keysight's ENA.

### (2) Measurement of Haze

Haze was measured based on ASTM E308 standards using HunterLab's equipment.

### (3) Measurement of Light Transmittance

Light transmittance (Transmittance) was measured at the wavelength range of 400 to 700nm based on ASTM D1003 standards using HunterLab's equipment.

### (4) Measurement of Glass Transition Temperature

The loss modulus and storage modulus of each film were obtained using DMA, and the inflection point in the tangent graph was used to measure the glass transition temperature (Tg).

TABLE 2

| | Df | | | Light |
|---|---|---|---|---|
| | (10 Ghz, | Tg | Haze | transmittance |
| | 23° C./50% RH) | (° C.) | (%) | (%) |
| Example 1 | 0.00285 | 304 | 2.5 | 53 |
| Example 2 | 0.00267 | 301 | 3.3 | 48 |
| Example 3 | 0.00257 | 302 | 3.2 | 50 |
| Example 4 | 0.00238 | 304 | 3.0 | 50 |
| Example 5 | 0.00281 | 303 | 2.7 | 52 |
| Example 6 | 0.00284 | 304 | 2.0 | 53 |
| Comparative | 0.0065 | 320 | 7.1 | 40 |
| Example 1 | | | | |
| Comparative | 0.0033 | 312 | 2.7 | 35 |
| Example 2 | | | | |
| Comparative | 0.00316 | 309 | 5.9 | 24 |
| Example 3 | | | | |

As shown in Table 2, the polyimide film manufactured according to the examples of the present disclosure had a dielectric dissipation factor in the range of 0.003 or less, which was significantly lower than the polyimide film of the comparative examples.

That is, the dielectric dissipation factors of the polyimide films of Comparative Examples 1 to 3 all exceeded 0.003.

In addition, the glass transition temperatures of the polyimide films manufactured according to the examples of the present disclosure were all 300° C. or more and less than 320° C.

In addition, the haze values of the polyimide films manufactured according to the examples of the present disclosure were all measured to be in the range of 3.5% or less.

In comparison, Comparative Example 1, which did not contain oxydiphthalic anhydride, showed a high haze value of 7.1% and a low light transmittance of 40%.

Meanwhile, in the case of Comparative Examples 2 and 3 in which the input order of the first and second dianhydride components was reversed from those of Examples 1 and 4, respectively, the measured haze values were 2.7% and 5.9, respectively, which showed higher haze values compared to Example 1 and Example 4 with the same composition ratios as Comparative Examples 2 and 3.

In addition, the light transmittance of the polyimide films of Comparative Examples 2 and 3 was measured to be 35% and 24%, respectively, showing a lower light transmittance compared to Examples 1 and 4.

That is, even in the case of a polyimide film with the same composition and composition ratio as in the examples, it was confirmed that not only the low dielectric (low dielectric dissipation factor) properties but also the light transmission properties of the film deteriorated depending on the input order of the dianhydride components.

Therefore, the inherent low dielectric loss, haze, light transmittance, and glass transition temperature of the polyimide film of the present disclosure can be achieved by the specified components, composition ratio, and manufacturing method (particularly, the input order of the dianhydride components), and also the polyimide film was found to be suitable for use for an electronic component that transmit signals at high frequencies in the Giga unit.

On the other hand, the polyimide films of Comparative Examples 1 to 3, which have different compositions or manufacturing methods from the examples, are expected to be difficult to use for an electronic component in which signal transmission is performed at a high frequency in the Giga unit in terms of one or more aspects of dielectric dissipation factor, haze, light transmittance, and glass transition temperature.

Although the present disclosure has been described with reference to examples of the present disclosure, those skilled in the art will be able to make various applications and modifications based on the contents within the scope of the present disclosure.

### INDUSTRIAL APPLICABILITY

As described above, the present disclosure provides a polyimide film containing certain components in a specific composition ratio and a method of manufacturing the same, thereby providing a low-cost polyimide film with low dielectric and translucent (low haze) properties. The low-cost, low-dielectric, and translucent polyimide film can be applied to various fields where the film is required, especially to an electronic component such as a flexible metal clad laminate.

1. A method of manufacturing a polyimide film, the method comprising:
(a) preparing a polyamic acid by polymerizing a first dianhydride component, a second dianhydride component, and a diamine component in an organic solvent; and
(b) forming a film of a precursor composition containing the polyamic acid on a support and then imidizing the film,
wherein the first dianhydride component is any one selected from the group consisting of oxydiphthalic anhydride (ODPA), biphenyltetracarboxylic dianhydride (BPDA), pyromellitic dianhydride (PMDA), and benzophenone tetracarboxylic dianhydride (BTDA),
the second dianhydride component is any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA),
the diamine component is at least one selected from the group consisting of paraphenylene diamine (PPD), diaminodiphenylether (ODA), m-tolidine, 1,3-bis(4-aminophenoxy)benzene (TPE-R), 1,4-bis(3-aminophenoxy)benzene (TPE-Q), 2,2-bis[4-(4-aminophenoxy)phenyl]propane (BAPP), 4,4′-diaminobenzanilide and 3,5-diaminobenzoic acid (DABA), and
the polyimide film has a dielectric dissipation factor (Df) in a range of 0.003 or less and a haze value in a range of 3.5% or less,
(but the first dianhydride component and the second dianhydride component are different from each other).

2. The method of claim 1, wherein the polyimide film has a light transmittance in a range of 45% or more and a glass transition temperature (Tg) in a range of 300° C. or more and less than 320° C.

3. The method of claim 1, wherein in the preparation of a polyamic acid, after the diamine component is added, the first dianhydride component is added and polymerized first, and then the second dianhydride component is added and polymerized.

4. The method of claim 1, wherein the first dianhydride component has a content in a range of 40 mol % or more to 95 mol % or less, and the second dianhydride component has a content in a range of 5 mol % or more to 60 mol % or less, based on 100 mol % of the dianhydride components of the polyimide film.

5. The method of claim 1, wherein the polyimide film further comprises a third dianhydride component with a content in a range of 5 mol % or less, based on 100 mol % of the dianhydride components of the polyimide film, and
the third dianhydride component is any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA) (but the third dianhydride component is different from the first dianhydride component and the second dianhydride component).

6. The method of claim 1, wherein the first dianhydride component, the second dianhydride component, and the diamine component are biphenyltetracarboxylic dianhydride (BPDA), oxydiphthalic anhydride (ODPA), and paraphenylene diamine (PPD), respectively.

7. A polyimide film manufactured by the manufacturing method of claim 1.

8-10. (canceled)

11. A polyimide film having a dielectric dissipation factor (Df) in a range of 0.003 or less and a haze value in a range of 3.5% or less.

12. The polyimide film of claim 11 having a light transmittance in a range of 45% or more and a glass transition temperature (Tg) in a range of 300° C. or more and less than 320° C.

13. The polyimide film of claim 11, wherein a first dianhydride component is any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA),
a second dianhydride component is any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA),
a diamine component is at least one selected from the group consisting of paraphenylene diamine (PPD), diaminodiphenylether (ODA), m-tolidine, 1,3-bis(4-aminophenoxy)benzene (TPE-R), 1,4-bis(3-aminophenoxy)benzene (TPE-Q), 2,2-Bis[4-(4-aminophenoxy)phenyl]propane (BAPP), 4,4′-diaminobenzanilide, and 3,5-diaminobenzoic acid (DABA), and
the first dianhydride component, the second dianhydride component, and the diamine component are subjected to an imidization reaction to obtain the polyimide film
(but the first dianhydride component and the second dianhydride component are different from each other).

14. The polyimide film of claim 11, wherein the first dianhydride component has a content in a range of 40 mol % or more to 95 mol % or less, and the second dianhydride component has a content in a range of 5 mol % or more to 60 mol % or less, based on 100 mol % of the dianhydride components of the polyimide film.

15. The polyimide film of claim 11, further comprising a third dianhydride component with a content in a range of 5 mol % or less, based on 100 mol % of the dianhydride components of the polyimide film,
wherein the third dianhydride component is any one selected from the group consisting of oxydiphthalic anhydride (ODPA), biphenyltetracarboxylic dianhydride (BPDA), pyromellitic dianhydride (PMDA), and benzophenonetetracarboxylic dianhydride (BTDA)
(but the third dianhydride component is different from the first dianhydride component and the second dianhydride component).

16. The polyimide film of claim 11, wherein the first dianhydride component, the second dianhydride component, and the diamine component are biphenyltetracarboxylic dianhydride (BPDA), oxydiphthalic anhydride (ODPA), and paraphenylene diamine (PPD), respectively.
